(19) United States
(12) Patent Application Publication
(10) Pub. No.: US 2015/0358839 A1
(43) Pub. Date: Dec. 10, 2015

(54) METHOD AND SYSTEM FOR TESTING A RADIO FREQUENCY DATA PACKET SIGNAL TRANSCEIVER AT A LOW NETWORK MEDIA LAYER

(71) Applicant: LITEPOINT CORPORATION, Sunnyvale, CA (US)

(72) Inventors: Christian Volf OLGAARD, Saratoga, CA (US); Ruizu WANG, San Ramon, CA (US)

(21) Appl. No.: 14/300,358

(22) Filed: Jun. 10, 2014

(51) Int. Cl. H04W 24/06

(52) U.S. Cl. CPC H04W 24/06

(57) ABSTRACT

Method and system for testing a radio frequency (RF) data packet signal transceiver device under test (DUT) by monitoring RF data packet signals between a tester and a DUT at a low network media layer, such as the physical (PHY) layer in accordance with the Open Systems Interconnection (OSI) reference model stack. By testing at a low layer, fewer signal conversions and data packet operations are required to perform various basic DUT tests, such as data packet throughput, DUT signal transmission performance, DUT packet type detection without packet decoding, validation of rate adaptation algorithms, and bit error rate (BER) testing.

### BACKGROUND

The present invention relates to testing a radio frequency (RF) data packet signal transceiver device under test (DUT), and in particular, testing such a DUT at a low network media layer.

Many of today's electronic devices use wireless technologies for both connectivity and communications purposes. Because wireless devices transmit and receive electromagnetic energy, and because two or more wireless devices have the potential of interfering with the operations of one another by virtue of their signal frequencies and power spectral densities, these devices and their wireless technologies must adhere to various wireless technology standard specifications.

When designing such wireless devices, engineers take extra care to ensure that such devices will meet or exceed each of their included wireless technology prescribed standard-based specifications. Furthermore, when these devices are later being manufactured in quantity, they are tested to ensure that manufacturing defects will not cause improper operation, including their adherence to the included wireless technology standard-based specifications.

For testing these devices following their manufacture and assembly, current wireless device test systems employ a subsystem for analyzing signals received from each device. Such subsystems typically include at least a RF data packet signal transmitter, such as a vector signal generator (VSG), for providing the source signals to be transmitted to the device under test, and a RF data packet signal receiver, such as a vector signal analyzer (VSA), for receiving and analyzing signals produced by the DUT. The production of test signals by the VSG and signal analysis performed by the VSA are generally programmable so as to allow each to be used for testing a variety of devices for adherence to a variety of wireless technology standards with differing frequency ranges, bandwidths and signal modulation characteristics.

One of the ultimate goals for communication systems, and wireless communication systems in particular, is achieving maximum data throughput. Currently, throughput is measured by running an application on top of the Transmission Control Protocol/Internet Protocol (TCP/IP) stack, which pushes data packets from one endpoint to another endpoint, and counts the number of data packets delivered during a defined time interval. One common issue with this process is that the final throughput result, normally in units megabits per second (Mbps), is frequently below the expected value, but the root cause is unknown, other than the general assumption that something is causing a reduction in the number of delivered packets as they traverse the TCP/IP stack.

As compared to wired communications, wireless communications are more error-prone. Therefore, following successful reception of a data packet within a short time interval specified by the standard, a receiver is generally required to respond by sending a confirmation, or acknowledgement (ACK), packet back to the source. Absent receipt of such a response, or a delay in its receipt beyond the response time interval specified by the applicable signal standard, the source will repeat transmission of the same data packet until a corresponding ACK is received or a system timeout occurs. Repeated sending of the same data packet diminishes the number of other successfully received data packets, and thereby reduces measured data packet throughput. Meanwhile, continuing to measure throughput in this manner, involving all layers of the TCP/IP stack, provides little if any information about the cause of any problems.

### SUMMARY

In accordance with the presently claimed invention, a method and system are provided for testing a radio frequency (RF) data packet signal transceiver device under test (DUT) by monitoring RF data packet signals between a tester and a DUT at a low network media layer, such as the physical (PHY) layer in accordance with the Open Systems Interconnection (OSI) reference model stack. By testing at a low layer, fewer signal conversions and data packet operations are required to perform various basic DUT tests, such as data packet throughput, DUT signal transmission performance, DUT packet type detection without packet decoding, validation of rate adaptation algorithms, and bit error rate (BER) testing.

In accordance with one embodiment of the presently claimed invention, a method for testing a radio frequency (RF) data packet signal transceiver device under test (DUT) at a low network media layer includes:

conveying to a DUT a first RF data packet signal having a first data packet signal duration T and including a first plurality of N data packets and a plurality of first bits B contained in the first plurality of N data packets;

receiving a second RF data packet signal originating from the DUT and including a second plurality of data packets with respective data packet start times and occupying respective frame intervals with respective frame interval start times;

responding to at least the second RF data packet signal by providing one or more test signals related to at least the second plurality of data packets; and

processing one or more test signals by performing one or more of
determining a ratio of B*N/T when the second RF data packet signal includes a plurality of DUT response packets responsive to the first RF data packet signal,
detecting one or more time differences, among the second plurality of data packets, between one or more of the respective data packet start times and one or more related ones of the respective frame interval start times,
detecting one or more data packet types included in the second RF data packet signal related to the respective frame intervals,
detecting a reduction in a data rate included in the second RF data packet signal related to one or more interruptions in a sequence of tester response packets included in the first RF data packet signal and responsive to the second RF data packet signal, or
detecting a number of the plurality of DUT response packets responsive to the first RF data packet signal while conveying the first RF data packet signal to the DUT with a plurality of signal powers.

An apparatus including a system for testing a radio frequency (RF) data packet signal transceiver device under test (DUT) at a low network media layer, comprising:

a signal path to

convey to a DUT a first RF data packet signal having a first data packet signal duration T and including a first plurality of N data packets and a plurality of first bits B contained in said first plurality of N data packets, and

to convey a second RF data packet signal originating from said DUT and including a second plurality of data packets with respective data packet start times and occupying respective frame intervals with respective frame interval start times;

signal monitoring circuitry coupled to said signal path and responsive to at least said second RF data packet signal by providing one or more test signals related to at least said second plurality of data packets; and

processing circuitry coupled to said signal monitoring circuitry and responsive to said one or more test signals by performing one or more of
determining a ratio of B*N/T when said second RF data packet signal includes a plurality of DUT response packets responsive to said first RF data packet signal,
detecting one or more time differences, among said second plurality of data packets, between one or more of said respective data packet start times and one or more related ones of said respective frame interval start times,
detecting one or more data packet types included in said second RF data packet signal related to said respective frame intervals,
detecting a reduction in a data rate included in said second RF data packet signal related to one or more interruptions in a sequence of tester response packets included in said first RF data packet signal and responsive to said second RF data packet signal, or
detecting a number of said plurality of DUT response packets responsive to said first RF data packet signal while conveying said first RF data packet signal to said DUT with a plurality of signal powers.

### BRIEF DESCRIPTION OF THE DRAWINGS

FIG. 1 depicts a representation of the Open Systems Interconnection (OSI) Reference Model stack.

FIG. 2 depicts data packets exchanged between a tester and a DUT for throughput testing in accordance with exemplary embodiments of the presently claimed invention.

FIG. 3 depicts data packets exchanged between a tester and a DUT for testing DUT data packet transmission performance in accordance with exemplary embodiments of the presently claimed invention.

FIG. 4 depicts a RF data packet signal containing multiple data packet types for testing a DUT in accordance with exemplary embodiments of the presently claimed invention.

FIG. 5 depicts a testing environment for testing a DUT in accordance with exemplary embodiments of the presently claimed invention.

### DETAILED DESCRIPTION

The following detailed description is of example embodiments of the presently claimed invention with references to the accompanying drawings. Such description is intended to be illustrative and not limiting with respect to the scope of the present invention. Such embodiments are described in sufficient detail to enable one of ordinary skill in the art to practice the subject invention, and it will be understood that other embodiments may be practiced with some variations without departing from the spirit or scope of the subject invention.

Throughout the present disclosure, absent a clear indication to the contrary from the context, it will be understood that individual circuit elements as described may be singular or plural in number. For example, the terms “circuit” and “circuitry” may include either a single component or a plurality of components, which are either active and/or passive and are connected or otherwise coupled together (e.g., as one or more integrated circuit chips) to provide the described function. Additionally, the term “signal” may refer to one or more currents, one or more voltages, or a data signal. Within the drawings, like or related elements will have like or related alpha, numeric or alphanumeric designators. Further, while the present invention has been discussed in the context of implementations using discrete electronic circuitry (preferably in the form of one or more integrated circuit chips), the functions of any part of such circuitry may alternatively be implemented using one or more appropriately programmed processors, depending upon the signal frequencies or data rates to be processed. Moreover, to the extent that the figures illustrate diagrams of the functional blocks of various embodiments, the functional blocks are not necessarily indicative of the division between hardware circuitry.

As noted above, throughput is a good metric for overall device performance and has typically been measured using an application that affects all layers of the ISO model from PHY through APP and results in packets being sent from one device to another over some defined time interval. Knowing the bit content of the packets sent, and the number of packets successfully received, one can calculate a throughput metric. However, as also noted above, this method offers little or no information about a root cause of lower-than-expected throughput. As discussed in more detail below, in accordance with exemplary embodiments of the presently claimed invention, testing of a RF data packet transceiver can be performed, at least in part, by testing at a low layer of the network data packet signal communications protocol.

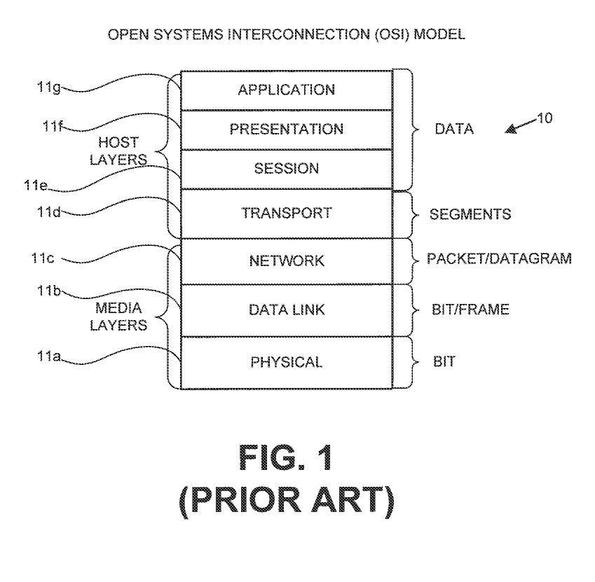

Referring to FIG. 1, the Internet Protocol Suite has a networking model referred to as the Open Systems Interconnection (OSI) Model 10. This model 10 includes media layers and host layers, which, in turn, together include seven layers: physical 11a, data link 11b, network 11c, transport 11d, session 11e, presentation 11f, and application 11g.

The physical (PHY) layer 11a defines electrical and physical specifications of the data connection, and the protocol to establish and terminate a connection over the communications medium. It may also define a protocol for flow control, a protocol for providing connections between network nodes, and the modulation or conversion between the representation of digital data and corresponding signals transmitted over the physical communications channel.

The data link layer 11b provides reliable links between directly connected network nodes, e.g., by detecting and correcting errors that may occur in the physical layer 11a.

The network layer 11c provides functional and procedural means of transferring variable length data sequences (referred to as datagrams) between nodes within the same network (with the network being multiple connected nodes, each of which has an address and is permitted to transfer messages to other nodes by providing message content and the address of the designated node).

The transport layer 11d provides reliable conveyance of data packets between nodes with addresses located on a network, thereby providing reliable data transfer services to the upper layers. A common example of a transport layer protocol in the standard internet protocol stack is TCP (Transmission Control Protocol), which is usually on top of the Internet protocol.

The session layer 11e controls connections (dialogues) between computers, by establishing, managing and terminating connections between local and remote applications. It provides for simplex, half-duplex or full-duplex operation, and establishes checkpointing, adjournment, termination and restart procedures.

The presentation layer 11f provides context between application layer entities, which may use different syntax and semantics. This layer also provides independence from data representation (e.g., encryption) by translating between application and network formats, thereby transforming data into the form the application will accept. This layer also formats and encrypts data to be sent across a network.

The application layer 11g is closest to the end user. Accordingly this layer 11g and the user interact directly with the software application. For example, this layer 11g interacts with software applications that implement communication components.

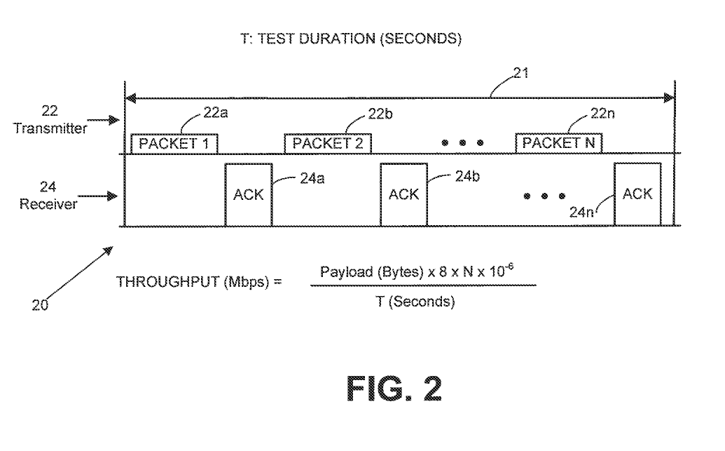

Referring to FIG. 2, in accordance with exemplary embodiments, testing for data packet throughput can be performed at low levels of the stack 10 (FIG. 1), including at the physical layer 11a. During testing, a series of data packets 20 are exchanged between the tester and DUT (a testing environment for which is discussed in more detail below). Data packets 22 are conveyed from the transmitter of the tester to the DUT, in response to which the DUT provides reply or confirmation packets 24, e.g., acknowledgment (ACK) packets. For example, for each data packet 22a, 22b, . . . , 22n provided by the tester and received correctly by the DUT, a corresponding responsive data packet 24a, 24b, . . . , 24n is provided by the DUT for reception by the tester to confirm successful reception of the test data packets 22a, 22b, . . . , 22n.

The reverse can also be performed where data packets 22 are conveyed from the transmitter of the DUT to the tester, in response to which the tester provides reply or confirmation packets 24, e.g., acknowledgment (ACK) packets. For example, for each data packet 22a, 22b, . . . , 22n provided by the DUT and received correctly by the tester, a corresponding responsive data packet 24a, 24b, . . . , 24n is provided by the tester for reception by the DUT to confirm successful reception of the DUT data packets 22a, 22b, . . . , 22n.

When testing data packet throughput, the test time 21 has a duration T during which the data packets 22 transmitted each include N bytes (for a total of B bits). Knowledge of data payload content, data encryption, data packet type, date bit rate, or other forms of metadata, is not necessary. Rather, for purposes of testing data bit throughput, only the number of bits per second (bps) is important, and can be determined at the lowest network layer.

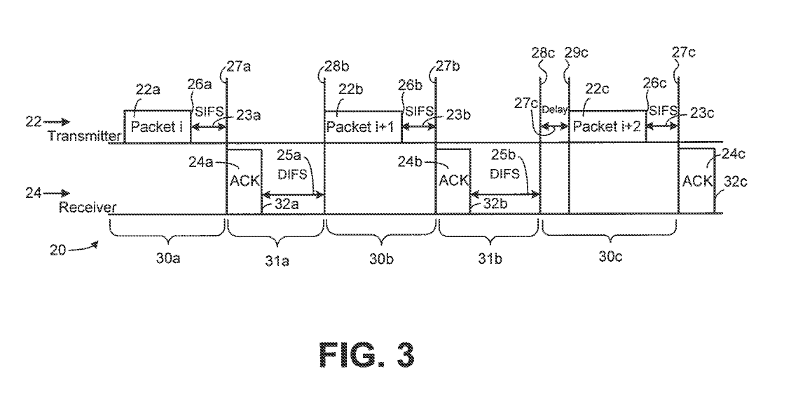

Referring to FIG. 3, in accordance with further exemplary embodiments, testing during an exchange of data packets 20 between a tester and a DUT can also be performed at the physical layer to determine whether and when the DUT is experiencing a performance issue at a higher layer of the OSI Model 10, above the physical layer 11a. For example, contention-based communication systems, such as Wi-Fi, a minimum idle time for signals conveyed via the communications medium (e.g., over the air (OTA) or via controlled impedance cabling) is required. Such idle time is referred to as Inter-Frame Space (IFS). Short Inter-Frame Space (SIFS) intervals 23a, 23b, 23c lie between the trailing edges 26a, 26b, 26c of the transmitted data packets 22a, 22b, 22c and the subsequent start times 27a, 27b, 27c of the frame intervals during which the responsive packets 24a, 24b, 24c are expected. Any gaps detected between packets that are longer than that specified by the IFS specification will be indicative of issues at a higher layer (e.g., a TCP/IP layer above the PHY layer).

Similarly, Distributed Coordination Function Inter-Frame Space (DIFS) intervals 25a, 25b lie between the trailing edges 32a, 32b of the responsive data packets 24a, 24b and the subsequent start times 28b, 28c of the transmit data packet frames 30b, 30c. By detecting a delay 27c during a leading portion of a transmit data packet frame interval 30c, it can be determined whether and when the DUT is experiencing an issue at a higher layer of the stack 10 (FIG. 1). (This can also be determined by detecting the effective duration of the transmitted data packet frame interval 30c during which this delay 27c is occurring.)

For example, the DIFS following the confirmation packet 24b for Packet i+1 is delayed. This could cause the DUT to re-send the packet at a reduced data rate and thereby reduce throughput during that time interval. The resulting PHY layer test results could indicate a higher-layer problem affecting the timing.

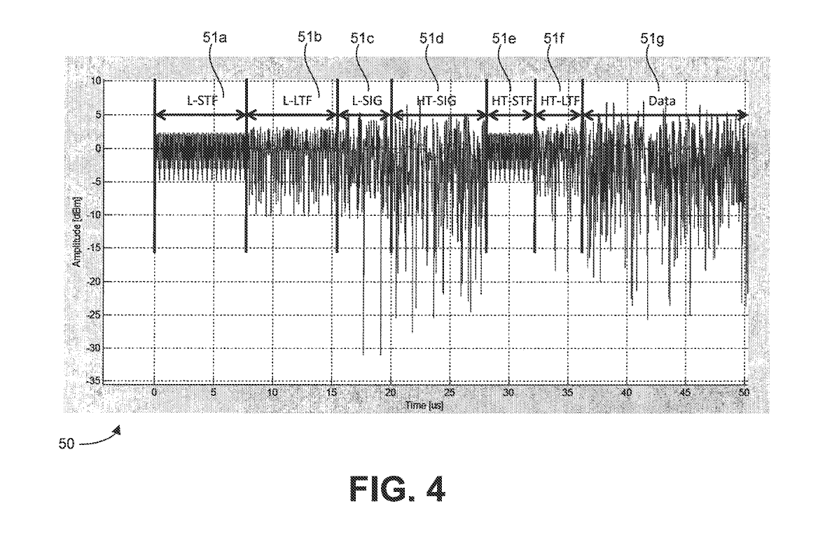

Referring to FIG. 4, depicting a packet and superimposed over it various portions of a full frame, in accordance with further exemplary embodiments, data packet types can be detected without requiring decoding of the data packets being received. For example, during physical transmission of a data packet signal 50 different data fields with different signal characteristics can be encountered. These include a legacy short training field (L-STF) 51a, legacy long training field (L-LTF) 51b and a legacy signal (L-SIG) 51c. Also included can be an HT signal (HT-SIG) 51d (used to detect presence of encoded data), short (HT-STF) 51e and long (HT-LTF) 51f high throughput training fields, and, finally, data bits 51g encoded in accordance with prescribed modulation and encoding methods. For a known packet duration and frame length, the data rate (also referred to as data type) can be readily identified, with no need for the packet to be captured and analyzed.

As will appreciated, for a given data payload length, the time interval necessary for transmitting such a data packet is a function of the data rate, also referred to as a data type. Hence, by detecting the length of a data packet frame interval, the corresponding data packet type for the detected data payload length can be determined. This can also include detection of the type of header data, thereby providing further granularity of the information about the data packet type. (Typically, for testing purposes, the data packet length is known, and will likely be the maximum data packet length in accordance with the particular signal standard being testing.)

In accordance with further exemplary embodiments, validation of rate adaptation algorithms can be tested. As is well known, rate adaptation is a fundamental primitive in wireless communication systems. The wireless signal strength can vary quickly and unpredictably. Accordingly, wireless transmitters have to constantly adapt data rates to ensure that the transmitted data packages reach their intended receivers and are accurately received and captured. Rate adaptation involves reducing the power of the received data package signal to the point where it ceases to be received accurately, and in response to which, the receiving circuitry ceases to transmit responsive data packets, such as acknowledgment packets. As a result, the transmitting circuitry, having failed to receive responsive data packets confirming reception of previously transmitted data packets, continues to transmit data packets, but does so using a reduced data rate. Further reductions in data rate can be introduced until such time as responsive data packets from the intended receiver resume. Hence, by negatively affecting the power level of the transmitted data packets (e.g., attenuating the transmitted data packets), and thereby interrupting continued transmission of responsive packets, subsequent responses by the transmitting device in the form of reduced data rates can be tested to confirm, or validate, correct operation of the rate adaptations algorithms being applied.

In accordance with further embodiments, bit error rate (BER) can also be tested, and BER data accumulated to produce what is frequently referred to as a waterfall curve, which is indicative of throughput versus distance. Distance can be simulated by using a variable attenuator in a controlled testing environment, i.e., by attenuating the signal strength of a transmitted signal by varying amounts to simulate changes in distance. By having the throughput measured at the physical layer 11A (FIG. 1), coupled with attenuator control, test time for performing this test to produce a waterfall curve can be significantly reduced.

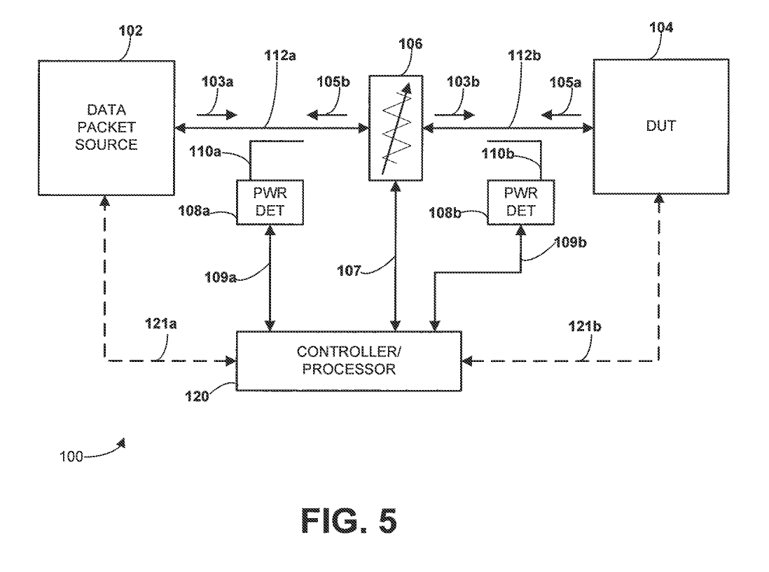

Referring to FIG. 5, a testing environment 100 for performing tests in accordance with exemplary embodiments includes a data packet signal source 102, a DUT 104, and a signal path (discussed in more detail below), including signal paths 112a 112b between the data packet signal source 102 and DUT 104 and mutually separated by a signal attenuator 106 that provides controllable signal attenuation for controlling the power levels of the data packet signals 103b received by the DUT 104 from the data packet signal source 102 and of the data packet signals 105b received by the data packet signal source 102 from the DUT 104 in response. The data packet signal source 102 can be implemented as a tester with a VSG and VSA (as discussed above) or as a known good data packet transceiver similar to the DUT 104.

In accordance with exemplary embodiments, and as depicted here, the signal paths 112a 112b are conductive, and implemented as coaxial RF cables connected to the data packet signal source 102, DUT 104 and signal attenuator 106 via coaxial RF connectors, all of which are well known in the art. Alternatively, however, one or both of the signal paths 112a 112b can be radiative, in which case the data packet signal source 102, DUT 104 and/or signal attenuator 106 communicate their respective signals 103a, 103b, 105a, 105b wirelessly (instead of coaxial RF cables) via antennas (instead of coaxial RF connectors).

Also included is power measurement or detection circuitry 108a, 108b coupled to the signal paths 112a, 112b via signal coupling circuitry 110a, 110b (discussed in more detail below) between the data packet signal source 102, DUT 104 and signal attenuator 106. This enables the power detectors 108a, 108b to monitor the signal levels (e.g., signal powers) of the signal 103a provided by the data packet signal source 102 and its corresponding attenuated signal 103b provided to the DUT 104, and the DUT transmit signal 105a and its corresponding attenuated signal 105b received by the data packet signal source 102. In accordance with preferred embodiments, these power detectors 108a, 108b detect the respective power envelopes of the data packet signals 103a, 103b, 105a, 105b. Corresponding power detection signals 109a, 109b are provided to a controller/processor 120. These power detection signals 109a, 109b can be analog signals representing the detected power envelopes, or in accordance with preferred embodiments, can be digital signals representing the detected power envelopes (e.g., of the data packets as shown in FIGS. 2 and 3) as well as other data packet signal characteristics, as desired.

In accordance with exemplary embodiments, and as depicted here, the signal coupling circuitry 110a, 110b are conductive, and implemented as RF signal power couplers or power dividers. (The couplers 110a, 110b appear here as directional couplers, but as will be appreciated in the context of the discussion herein, are preferably implemented to enable sensing, detecting or measuring power in both directions.) Alternatively, however, with reference to the discussion above, one or both of the couplers 110a, 110b can be “wireless”, e.g., implemented as antennas to sense, detect or measure power of the data packet signals 103a, 103b, 105a, 105b when they are conveyed wirelessly between the data packet signal source 102, DUT 104 and signal attenuator 106.

The controller/processor 120 also provides control signals 107 to the signal attenuator 106 to establish the desired level of data packet signal attenuation during testing.

By using such a testing configuration 100, it can be determined at the physical (PHY) layer how many data packets 103a have been transmitted and how many confirmation response packets 105a have been returned during a defined time interval. Such a test configuration 100 enables determinations of packet duration and direction based on duration of packet signal power and comparative power levels. For example, with signal attenuation applied by the signal attenuator 106, the power detectors 108a, 108b will provide power detection signals 109a, 109b indicating that the source packet signal 103a has a higher power level than the packet signal 103b received by the DUT 104. Conversely, when the power detectors 108a, 108b provide power detection signals 109a, 109b indicating a higher power signal 105a on the DUT side of the attenuator 106 than the power level of the signal 105b on the source side of the attenuator 106, it is known that the data packet signals are originating from the DUT 104.

Alternatively, the data packet signal source 102 and DUT 104 can provide receive (RX) and transmit (TX) switching information 121a, 121b indicating the source of the data packet signals 103a, 103b, 105a, 105b being monitored and detected.

In accordance with all embodiments, the power detection signals 109a, 109b are processed by the controller/processor 120 to determine packet duration, e.g., based upon detected packet start and stop times, numbers of data packets, etc. In accordance with a preferred embodiment, the controller/processor 120, can be implemented using logic circuitry such as a field programmable gate array (FPGA) for processing the digital data provided by the power detection signals 109a, 109b (e.g., performing pattern recognition in the time domain of the detected data packets), and the optional switching signal data 121a, 121b.

Various other modifications and alterations in the structure and method of operation of this invention will be apparent to those skilled in the art without departing from the scope and the spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A method for testing a radio frequency (RF) data packet signal transceiver device under test (DUT) at a low network media layer, comprising:
conveying to a DUT a first RF data packet signal having a first data packet signal duration T and including a first plurality of N data packets and a plurality of first bits B contained in said first plurality of N data packets;
receiving a second RF data packet signal originating from said DUT and including a second plurality of data packets with respective data packet start times and occupying respective frame intervals with respective frame interval start times;
responding to at least said second RF data packet signal by providing one or more test signals related to at least said second plurality of data packets; and
processing said one or more test signals by performing one or more of
determining a ratio of B*N/T when said second RF data packet signal includes a plurality of DUT response packets responsive to said first RF data packet signal,
detecting one or more time differences, among said second plurality of data packets, between one or more of said respective data packet start times and one or more related ones of said respective frame interval start times,
detecting one or more data packet types included in said second RF data packet signal related to said respective frame intervals,
detecting a reduction in a data rate included in said second RF data packet signal related to one or more interruptions in a sequence of tester response packets included in said first RF data packet signal and responsive to said second RF data packet signal, or
detecting a number of said plurality of DUT response packets responsive to said first RF data packet signal while conveying said first RF data packet signal to said DUT with a plurality of signal powers.

2. The method of claim 1, wherein said responding to at least said second RF data packet signal by providing one or more test signals related to at least said second plurality of data packets comprises detecting a power envelope of said second RF data packet signal.

3. The method of claim 2, wherein said responding to at least said second RF data packet signal by providing one or more test signals related to at least said second plurality of data packets further comprises providing, as said one or more test signals, one or more digital signals representing said power envelope.

4. The method of claim 1, wherein said processing said one or more test signals comprises processing said baseband digital signal at a physical (PHY) layer in accordance with the Open Systems Interconnection (OSI) reference model stack.

5. The method of claim 1, wherein said baseband digital signal comprises a baseband digital signal with a plurality of bits corresponding to a plurality of second bits contained in said second plurality of data packets.

6. The method of claim 1, wherein said plurality of DUT response packets comprises a plurality of acknowledgment packets.

7. The method of claim 1, wherein said one or more time differences comprise one or more time delays between one or more of said respective data packet start times and one or more related ones of said respective frame interval start times.

8. The method of claim 1, wherein said one or more time differences include one or more increases in said respective defined frame intervals.

9. The method of claim 1, wherein said sequence of tester response packets comprises a sequence of acknowledgment packets.

10. The method of claim 1, wherein said detecting a reduction in a data rate included in said second RF data packet signal related to one or more interruptions in a sequence of tester response packets included in said first RF data packet signal and responsive to said second RF data packet signal comprises refraining from including one or more tester response packets in said first RF data packet signal.

11. The method of claim 1, wherein said detecting a reduction in a data rate included in said second RF data packet signal related to one or more interruptions in a sequence of tester response packets included in said first RF data packet signal and responsive to said second RF data packet signal comprises attenuating said first RF data packet signal.

12. The method of claim 1, wherein said detecting a number of said plurality of DUT response packets responsive to said first RF data packet signal while conveying said first RF data packet signal to said DUT with a plurality of signal powers comprises attenuating said first RF data packet signal.

13. An apparatus including a system for testing a radio frequency (RF) data packet signal transceiver device under test (DUT) at a low network media layer, comprising:
a signal path to
convey to a DUT a first RF data packet signal having a first data packet signal duration T and including a first plurality of N data packets and a plurality of first bits B contained in said first plurality of N data packets, and
to convey a second RF data packet signal originating from said DUT and including a second plurality of data packets with respective data packet start times and occupying respective frame intervals with respective frame interval start times;
signal monitoring circuitry coupled to said signal path and responsive to at least said second RF data packet signal by providing one or more test signals related to at least said second plurality of data packets; and
processing circuitry coupled to said signal monitoring circuitry and responsive to said one or more test signals by performing one or more of
determining a ratio of B*N/T when said second RF data packet signal includes a plurality of DUT response packets responsive to said first RF data packet signal,
detecting one or more time differences, among said second plurality of data packets, between one or more of said respective data packet start times and one or more related ones of said respective frame interval start times,
detecting one or more data packet types included in said second RF data packet signal related to said respective frame intervals,
detecting a reduction in a data rate included in said second RF data packet signal related to one or more interruptions in a sequence of tester response packets included in said first RF data packet signal and responsive to said second RF data packet signal, or
detecting a number of said plurality of DUT response packets responsive to said first RF data packet signal while conveying said first RF data packet signal to said DUT with a plurality of signal powers.

14. The apparatus of claim 13, wherein said signal monitoring circuitry comprises power detection circuitry.

15. The apparatus of claim 13, wherein said processing circuitry comprises logic circuitry.

16. The apparatus of claim 13, wherein said processing circuitry comprises field programmable gate array circuitry.
